(19) United States
(12) Patent Application Publication
(10) Pub. No.: US 2005/0169511 A1
(43) Pub. Date: Aug. 4, 2005

(54) Document processing system using primary and secondary pictorial image comparison

(75) Inventor: William J. Jones, Barrington, IL (US)

Correspondence Address: CUMMINS-ALLISON CORP.;C/O JENKENS & GILCHRIST, 225 WEST WASHINGTON STREET, SUITE 2600, CHICAGO, IL, 60606, US

(73) Assignee: Cummins-Allison Corp., Mount Prospect, IL (US)

(21) Appl. No.: 10/769,406

(22) Filed: Jan. 30, 2004

(51) Int. Cl. G06K 9/00

(52) U.S. Cl. 382/135; 382/137

(57) ABSTRACT

A document identification system having an input and output receptacle, a transport path, and an image scanner. Primary visible pictorial images and secondary invisible pictorial images are captured by the image scanner. A processor compares the primary and secondary captured pictorial images with master primary and secondary pictorial images to determine the identity of the document, such as denomination or authentication.

### BACKGROUND OF THE INVENTION

1. Technical Field of the Invention

The present invention relates to document identification and authentication. More particularly, but not by way of limitation, the present invention relates to an apparatus and method for identifying and authenticating documents, such as currency bills, by detecting the presence of a primary (visual) pictorial image and a secondary (ultraviolet (UV)/infrared (IR)/magnetic) pictorial image.

2. Description of Related Art

It is known that a pictorial image of a document may be useful in determining the identity and/or authenticity of a document. The pictorial image may be of a portion of the document, or of the full document. In making identification and authentication determinations, characteristic features, such as visible pictorial images, are analyzed for the presence of graphic features.

It is also known that with the advent of color copiers and color laser printers, the ability to counterfeit certain documents, such as currency bills, has become much easier. It is also known that various methods and apparatuses exist for identifying and authenticating documents.

For example, it is known that by comparing IR reflectivity of color copier (inorganic ink) counterfeits and authentic (organic ink) notes, the authenticity of the note may be determined. In addition, it is a known method to use a UV light source which illuminates a document to be authenticated. A UV light detector generates an output signal which is responsive to the composite UV light reflected from the overall document. A signal processor receives the composite UV output signal and determines the authenticity of the document based on a comparison of the output signal to a threshold. However, these methods and apparatuses are subject to a high rate of incorrect authentication determinations.

In addition, it is known in the art to authenticate and identify financial documents by breaking up the surface thereof into several zones. The zones are analyzed for characteristic features. The characteristic features are dependent on the denomination of notes. This method, while susceptible to a lower rate of incorrect authentication determinations, is time consuming and minimizes the throughput of the document denominator and authenticator.

Based upon the foregoing, there is a need for an efficient method and apparatus for determining the identity and authenticity of financial documents. The method should minimize processing time and incorrect authentication determinations.

### SUMMARY OF THE INVENTION

The present invention satisfies the foregoing and other needs in the art by providing a document identifier which is capable of detecting a primary pictorial image and secondary pictorial image which are specific to a certain type of document. The primary and secondary pictorial images, which may be visible in different regions of the electromagnetic spectrum or under magnetic detection, provide at least two separate pictorial indicia for identifying a document. This dual comparison results in a lower likelihood of an incorrect identification of the document. Identification in this context includes identifying the type of document, denomination of the document, and/or authentication of the document.

In accordance with one embodiment of the present invention, the device comprises primary and secondary pictorial image scanners for capturing primary and secondary pictorial images from at least one face of a financial document. A processor in communication with the image scanners compares master primary and secondary pictorial images with the captured primary and secondary pictorial images to determine the identity of the financial document.

In yet another embodiment of the present invention, the image scanner captures on at least a portion of at least one face of the financial document the primary and secondary pictorial images.

In still another embodiment of the present invention, the device includes at least one input receptacle for receiving a stack of financial documents to be identified. In another embodiment, the device includes at least one output receptacle for the receipt of the financial documents from the input receptacle. In yet another embodiment, the financial documents are transported from the input receptacle, through the image scanner, and to the output receptacle by a transport mechanism.

In yet another embodiment of the present invention, a method is used wherein the processor captures the primary visible and secondary V, IR or magnetic pictorial images on at least a portion of at least one face of the document. The captured pictorial images are compared to previously identified master images to determine the identity of the financial document.

Thus, because the imaging process captures both the primary and secondary pictorial images, the process of identification is more accurate. This may be advantageous in financial institutions where a large number of documents must be processed in a timely manner.

### BRIEF DESCRIPTION OF THE DRAWINGS

The foregoing and other advantages of the invention will become apparent upon reading the following detailed description and upon reference to the drawings.

FIGS. 1a-1f illustrate various primary and secondary images on an exemplary currency bill type financial document;

FIG. 2 illustrates a block diagram of an exemplary identification device in accordance with an embodiment of the present invention;

FIG. 3 illustrates a functional diagram of the exemplary identification device shown in FIG. 2; and

FIG. 4 shows a flowchart illustrating a method of identifying a document.

### DESCRIPTION OF ILLUSTRATIVE EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

When describing various embodiments of the present invention, the term financial documents includes both currency documents and non-currency documents. The term currency bills or bills refers to official currency bills. The term currency documents includes both currency bills and substitute currency media. Examples of substitute currency media include, but are not limited to, casino tickets such as “EZ Pay” tickets or “Quicket”, or promotional media, such as “Disney Dollars” or Toys 'R Us “Geoffrey Dollars”. Also included are retailer coupons, gift certificates, gift cards, or food stamps. Substitute currency media may include a barcode, which is referred to as a barcoded ticket.

The term non-currency documents includes any type of document. Examples of such documents include checks, deposit slips, withdrawal slips, coupon and loan payment documents, food stamps, cash tickets, and all other documents used for transactions at financial institutions. This may include not only deposits and withdrawals but also loan applications, credit card applications, student loan applications, accounting invoices, debit forms, account transfer forms, and all other types of forms with predetermined fields.

The term “pictorial” as used here means and refers to a visual representation or image of a person, place or thing and does not refer to or encompass text, words, numbers, and the like.

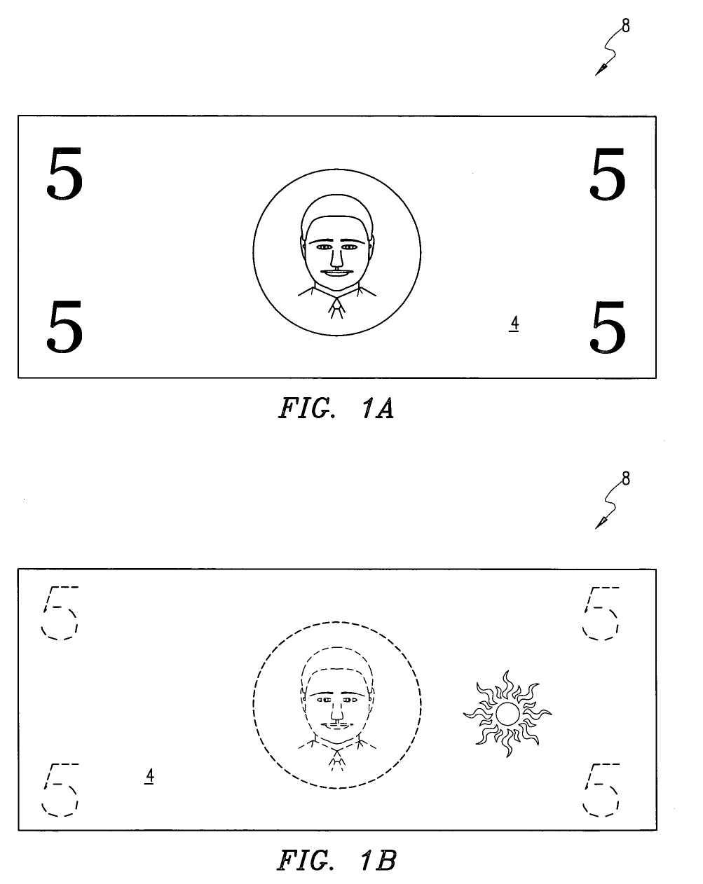

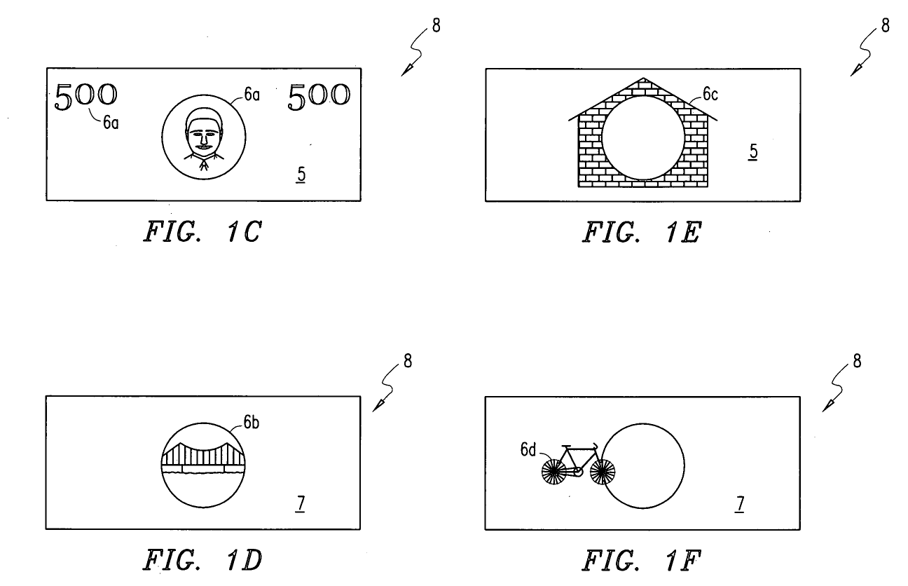

Several exemplary financial documents 8, a specific example of which is a currency bill, which are detectable using the techniques, processes and apparatus of the present invention are shown in FIGS. 1a-1f.

FIG. 1a illustrates the front face 4 of the document 8 with its pictorial image(s) which is(are) not printed with magnetic or conductive ink (and which are most likely recognizable under visible light). FIG. 1b illustrates the front face 4 of the same document 8 with its pictorial image(s) which is(are) printed with magnetic or conductive ink (and which may or may not be recognizable under visible light). In regard to the pictorial images, the pictorial image that is not printed with magnetic/conductive ink (and is perhaps visible to the naked eye in visible light) may, for example, be referred to as the primary pictorial image, and the pictorial image printed with magnetic/conductive ink (which may be invisible) may, for example, be referred to as the secondary (or latent) pictorial image. The primary pictorial image includes at least the bill denomination and the portrait, while the secondary pictorial image includes at least the image of a blazing sun. Prior art techniques may make overall magnetic flux sensing determination with respect to the document 8, or detect that certain alphanumeric characters are printed with magnetic ink, for providing information indicative of identification and/or authenticity. In accordance with an aspect of the present invention, magnetic flux or conductive sensing is performed on a pixel-by-pixel basis to obtain a pictorial image of the document with respect to its magnetic/conductive ink printed pictorial components (visible or invisible). This magnetic/conductive pictorial image, along with an optical image of the primary pictorial image, can then be compared to master pictorial images for an authentic document in order to make identification and authentication determinations.

FIGS. 1c and 1d illustrate the front face 5 and rear face 7 of the document 8 with its pictorial image(s) which is(are) recognizable under visible light. FIGS. 1e and 1f illustrate the front face 5 and rear face 7 of the same document 8 with its pictorial image(s) which is(are) visible under UV (or IR) light. In regard to the pictorial images, the pictorial image that is visible to the naked eye in visible light may, for example, be referred to as the primary pictorial image, and the pictorial image visible under UV or IR light may, for example, be referred to as the secondary (or latent) pictorial image. It will be noted that in a preferred embodiment the secondary pictorial image is not readily visible (or is in fact invisible) to the naked eye. In the exemplary currency bill shown, the primary pictorial images 6a include, at least, the numbers 500 and a portrait on the front face 5 of FIG. 1c, and the bridge structure 6b on the rear face 7 of FIG. 1d. The secondary pictorial images include, at least, the house 6c on the front face 5 of FIG. 1e and the bycycle 6d on the rear face 7 of FIG. 1f. In accordance with an aspect of the present invention, optical image sensing is performed on a pixel-by-pixel basis to obtain a pictorial image of the document with respect to both its visible and/or invisible (UV/IR) pictorial image components. These pictorial images can then be compared to master images for an authentic document in order to make identification and authentication determinations.

It is also noted that in any of the FIG. 1a-1f examples, the primary and secondary pictorial images can be printed using optical variable feature technology. In this technology, the appearance of the printed pictorial image changes (perhaps in shape, perhaps in color, perhaps in reflectivity) depending on the angle with which the pictorial image is viewed. As an example, using optical variable ink to print the image of the bridge in FIG. 1d, that pictorial image could appear as one distinct color when viewed from a first angle and a second distinct color when viewed from a second angle. In this instance, the primary and secondary images are the same, but their observability changes. In another implementation, different types of optical variable ink could be used on the different primary and secondary images. As another example, an anti-scan pattern technique can be used to print the primary and secondary images. As another example, the primary and secondary images may be embedded in a hologram. Any suitable optical variable device or technique could be used.

A device and method according to the principles of the present invention utilizes detection of the primary and secondary pictorial images to identify and/or authenticate and/or denominate a scanned financial document 8. Although the front face 5 and rear face 7 of the financial document 8 could comprise both primary and secondary pictorial images, other embodiments according to the principles of the present invention may evaluate only one primary/secondary pictorial image on either a front or rear face of a financial document. Also, a primary pictorial image may be visible in both the visible and non-visible (UV or IR) regions of the electromagnetic spectrum and/or through magnetic/conductive detection. Still further, the primary and secondary images may be viewable at different observation angles.

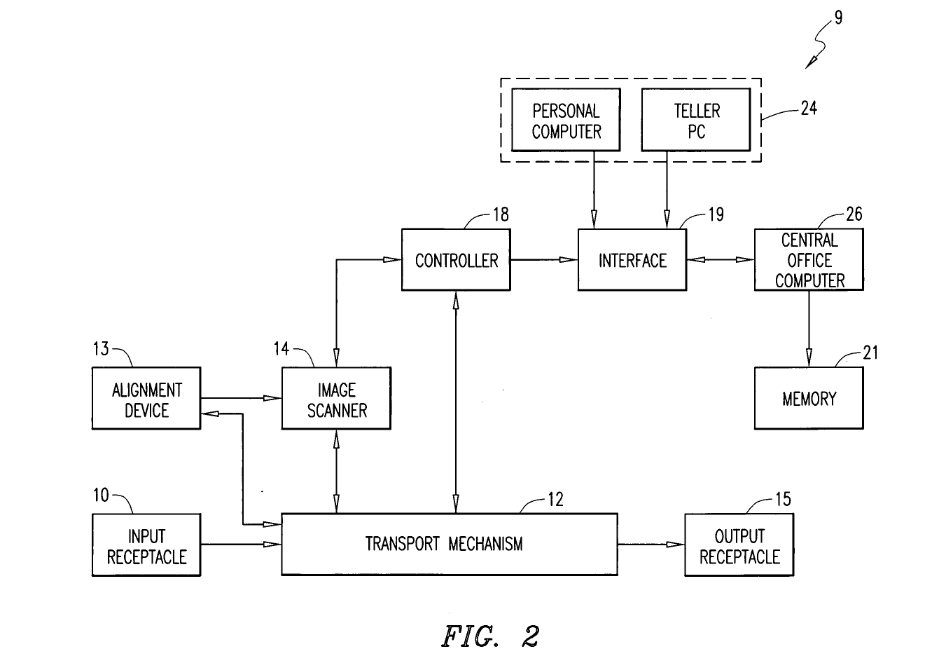

Referring now to FIG. 2, there is illustrated a block diagram of an identification device 9 according to an embodiment of the present invention. An input receptacle 10 is adapted for the receipt of financial documents, such as stock certificates, checks, and currency bills, and the like. On one of more faces of these financial documents is included a primary and secondary pictorial image as described above. A transport mechanism 12 is provided for transporting documents past an pictorial image (for example, optical—visible/UV/IR—and/or magnetic/conductive and/or multiple angle) scanner 14 and into one or more output receptacles 15. The pictorial image scanner 14 may be either a partial pictorial image scanner or a full pictorial image scanner. The partial pictorial image scanner captures only a portion of the face of a document of interest. For example, with reference to FIG. 1b, the partial pictorial image scanner (for magnetic/conductive) may only capture a pictorial image of the area where it expects to find the ship, and not capture an image of the entire document. Similarly, with reference to FIG. 1f, the partial pictorial image scanner (for UV/IR) may only capture a pictorial image of the area where it expects to find the elephant, and not capture an image of the entire document. Still further, in the case of optical variable features, imaging at one angle would occur only where the primary image associated with that angle is to be found, while imaging at another angle occurs at the location where the secondary image is to be found.

A processor 18 controls the speed of the transport mechanism and collects electronic data output from the pictorial image scanner 14. The electronic data represents the scanned primary and secondary pictorial images. Once the electronic data is collected by the processor 18, the primary and secondary pictorial images are identified and the document can be identified, authenticated and/or denominated by comparing the captured pictorial images with authentic pictorial images stored in memory 21. Memory 21 as well as a user of the identification device 9 may interface with the processor 18 via interface 19.

Ancillary to the processor 18 is an alignment device 13 which correlates the scanning function of the scanner 14 to the dimensions of documents transported by transport mechanism 12. In this way, the operation of the scanner 14 is aligned to capture the primary and secondary pictorial images from the proper locations on the document. In another embodiment, the scanner 14 may scan the entire document, while the processor 18 processes the resulting image of the document to retrieve the primary and secondary pictorial images.

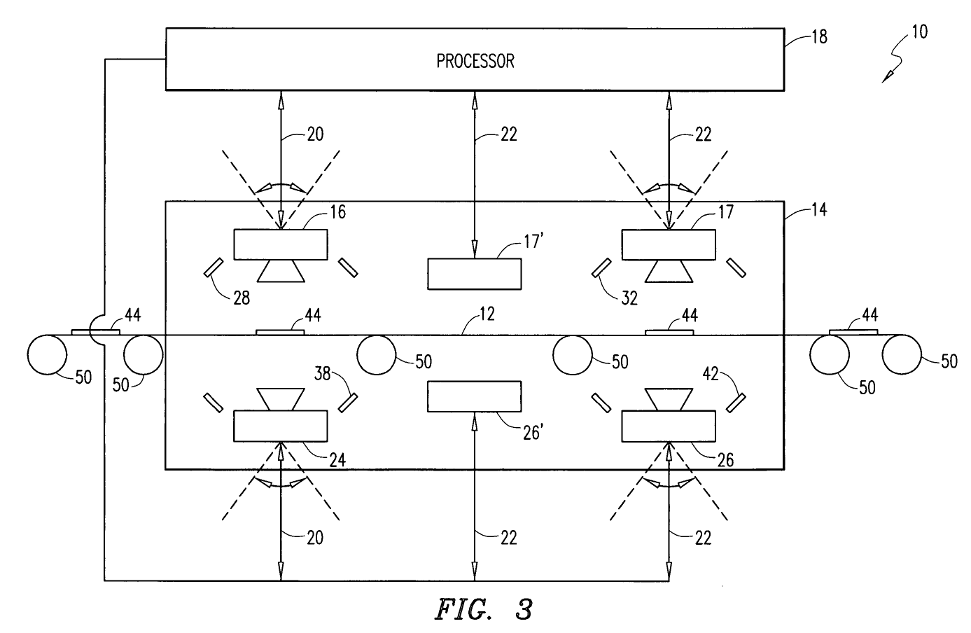

Referring now to FIG. 3, there is illustrated a functional diagram of one exemplary embodiment 10 of the image scanner 14, transport mechanism 12 and controller 18 of FIG. 2. Image scanner 14 includes visible cameras 16 and 24 along with visible light sources 28 and 38 for the purpose of capturing the primary pictorial image. The visible cameras 16 and 24 may comprise any suitable video or digital imaging camera, perhaps of the CCD or CMOS array variety. The image scanner 14 further includes one or more of a) UV and/or IR cameras 17 and 26 along with UV/IR light sources 32 and 42, and b) magnetic/conductive sensors 17′ and 26′ capable of making pixel-by-pixel resolution magnetic flux/conductivity determinations. The UV/IR cameras 17 and 26 may comprise any suitable video or digital imaging camera, perhaps of the CCD or CMOS array variety. The sensors 17′ and 26′ for making magnetic detection may comprise any suitable multi-pixel magnetic flux detection (perhaps in a linear or rectangular array) sensor, and can be based of the technology utilized for MICR readers. The sensors 17′ and 26′ for making conductivity detection may comprise any suitable multi-pixel conductivity detection (perhaps in a linear or rectangular array) sensor, and can be based of the technology utilized for capacitive sensor arrays. Cameras 17 and 26 and/or sensors 17′ and 26′ are provided for capturing the secondary pictorial images on either side of an exemplary financial document 44. It will be recognized that in some implementations, cameras/sensors are needed on only one side of the exemplary financial document 44. IR or UV cameras 17 and 26 may be either solely IR, or solely UV, or both IR and UV cameras. It will also be recognized that plural cameras/sensors can be oriented at different angles (generally indicated by the dotted angles associated with each device) with respect to the same or different surfaces of the document to detect differences in imaging caused when the primary and secondary images are rendered using optical variable feature technology. Rollers 50 are provided to move the exemplary financial documents past the image scanner 14. Rollers 50 may also be used to align the position of the documents with respect to the cameras/sensors 16, 17, 17′ 24, 26 and 26′.

As the exemplary financial document 44 is transported through the image scanner 14 by the transport mechanism 12, light sources 28, 32, 38, and 42 illuminate the financial document (or a portion thereof) while cameras 16, 17, 24 and 26 capture primary and secondary pictorial optical images from at least one surface of exemplary financial document 44. At the same time, the sensors 17′ and 26′ capture the secondary pictorial magnetic images from at least one surface of exemplary financial document 44. The foregoing is by example only as any of the cameras/sensors can be selectively used for primary/secondary image capture. The processor 18 retrieves the visible and UV/IR/magnetic pictorial images (or a part thereof) from the cameras/sensors 16, 17, 17′ 24, 26 and 26′ via data links 20 and 22. The processor then compares both the secondary UV/IR/magnetic/conductive and primary visible pictorial images to a master UV/IR/magnetic/conductive and visible pictorial image of a genuine document. Next, the document is identified and/or denominated and/or authenticated if the visible pictorial image(s) matches the stored visible primary pictorial image(s) of the master document and the UV/IR/magnetic/conductive secondary pictorial images matches the stored UV/IR/magnetic/conductive pictorial image(s) of the master document.

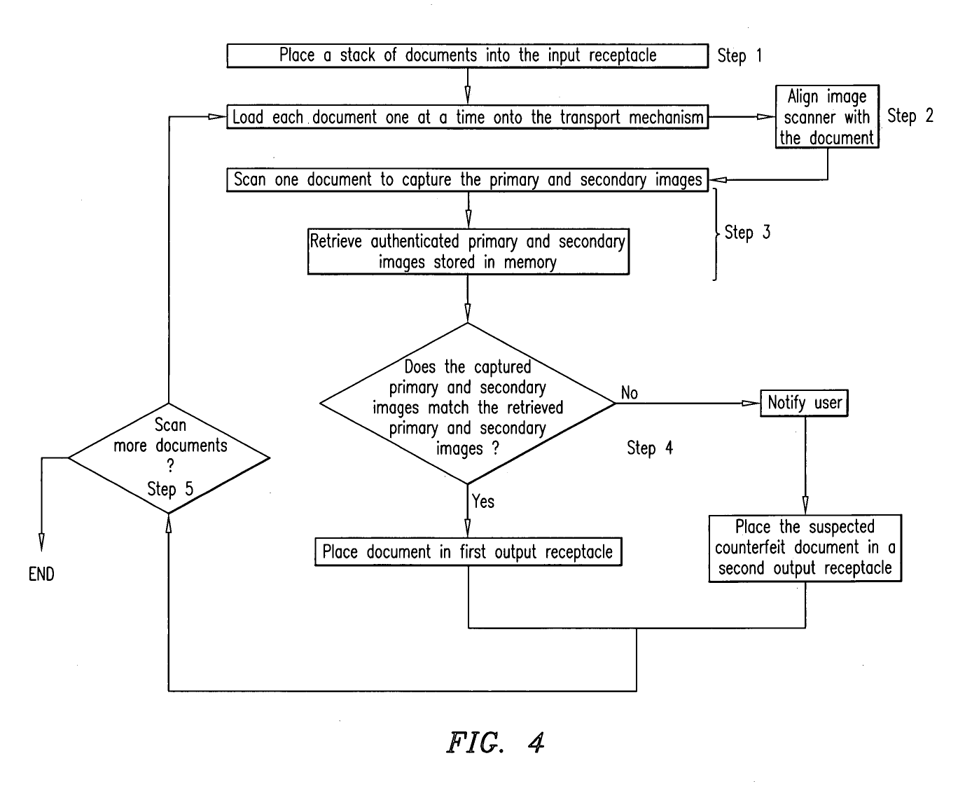

In operation, with reference to FIG. 4, a user places a stack of documents into the input receptacle (step 1). The documents are then loaded one at a time onto the transport mechanism, and the image scanner 14 (see, FIGS. 2 and 3) is aligned with the documents (step 2). The primary and secondary pictorial images are then captured by the image scanner and compared by the processor with authentic primary and secondary pictorial images (step 3). In step 4, if the captured primary and secondary pictorial images match the retrieved or master primary and secondary pictorial images, the document is identified and may be placed in a first output receptacle. The processor may then proceed to the next document (step 5). If, in step 4, the captured primary and/or secondary pictorial images do not match the master pictorial images, the document is identified or flagged as a suspect counterfeit document and is placed in a second output receptacle.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A system, comprising:
an imager to capture a primary pictorial image and a secondary pictorial image on at least one face of a document to be identified; and
a processor to compare the captured primary pictorial image and the secondary pictorial image with a master primary pictorial image and a master secondary pictorial image, respectively, for a known document in order to identify the document.

2. The system according to claim 1, wherein one of the primary/secondary pictorial images is visible in visible light and the other of the primary/secondary pictorial images is invisible in visible light.

3. The system according to claim 1, wherein the identification of the document includes at least one of a type of document, denomination of the document, and authenticity of the document.

4. The system according to claim 3, wherein the documents comprise at least one of currency bills and checks.

5. The system according to claim 4, wherein the imager to capture the primary pictorial image and the secondary pictorial image is an image scanner.

6. The system according to claim 5, wherein the image scanner comprises a visible image scanner that captures one of the primary/secondary pictorial images visible in the visible spectrum, and a non-visible image scanner that captures the other of the primary/secondary pictorial images in the non-visible spectrum.

7. The system according to claim 6, wherein the image scanner is a full image scanner.

8. The system according to claim 7, wherein the image scanner is a partial image scanner.

9. The system according to claim 1, wherein the primary pictorial image is the same as secondary pictorial image.

10. The system according to claim 1, further comprising a memory for storing the master primary pictorial image and the master secondary pictorial image of the known document.

11. The system according to claim 10, further comprising a graphical user interface that accepts commands from a user of the system for input into the processor.

12. The system according to claim 1, further comprising:
at least one input receptacle adapted to receive a stack of documents to be identified;
at least one output receptacle adapted to receive the documents after imaging; and
a transport mechanism operable to transport each document past the imager to the output receptacle.

13. The system according to claim 12, further comprising an alignment mechanism operable to align image scanning to a dimension of the document.

14. A method for document processing, comprising:
capturing a primary pictorial image and a secondary pictorial image from at least a portion of at least one face of a document; and
identifying the document by comparing the captured pictorial images with master primary and secondary pictorial images.

15. The method of claim 14 wherein one of the primary/secondary pictorial images is visible in visible light and the other of the primary/secondary pictorial images is invisible in visible light.

16. The method of claim 14, wherein identifying the document includes identifying at least one of the type of document, the denomination of the document, and the authenticity of the document.

17. The method according to claim 16, wherein capturing the primary pictorial image and the secondary pictorial image comprises scanning at least a portion of the document on which the primary and secondary pictorial images are located.

18. The method according to claim 17, wherein scanning comprises scanning the entire document.

19. The method according to claim 17, wherein scanning the primary pictorial image comprises scanning the primary pictorial image in the visible region of the spectrum.

20. The method according to claim 19, wherein scanning the secondary pictorial image comprises scanning the secondary image in the non-visible region of the spectrum.

21. The method according to claim 15, further comprising of storing the master primary visible pictorial images and secondary invisible pictorial images.

22. A system, comprising:
a first optical imager to capture a visible pictorial image on at least one face of a document to be identified;
a second optical imager to capture an UV pictorial image on at least one face of the document to be identified; and
a processor to compare the captured visible pictorial image against a master visible pictorial image for a known document and compare the captured UV pictorial image with a master UV pictorial image for the genuine document and output an indication, if the comparison indicates a match in images, identifying the document to be of a same type as the known document.

23. The system according to claim 22, wherein the indication identifies the document to be authentic.

24. The system according to claim 22, wherein the indication identifies the document to be of a certain denomination.

25. The system according to claim 22, wherein the document to be identified comprises at least one of a currency bill and a check.

26. The system according to claim 22, wherein the first and second optical imagers capture the visible and UV pictorial images of the full document to be identified.

27. The system according to claim 22, wherein the first and second optical imagers capture the visible and UV pictorial images of a selected portion of the full document to be identified.

28. The system according to claim 22, further comprising a memory for storing the master visible pictorial image and the master UV pictorial image for the known document.

29. A system, comprising:
a first optical imager to capture a visible pictorial image on at least one face of a document to be identified;
a second optical imager to capture an IR pictorial image on at least one face of the document to be identified; and
a processor to compare the captured visible pictorial image against a master visible pictorial image for a known document and compare the captured IR pictorial image with a master IR pictorial image for the genuine document and output an indication, if the comparison indicates a match in images, identifying the document to be of a same type as the known document.

30. The system according to claim 29, wherein the indication identifies the document to be authentic.

31. The system according to claim 29, wherein the indication identifies the document to be of a certain denomination.

32. The system according to claim 29, wherein the document to be identified comprises at least one of a currency bill and a check.

33. The system according to claim 29, wherein the first and second optical imagers capture the visible and IR pictorial images of the full document to be identified.

34. The system according to claim 29, wherein the first and second optical imagers capture the visible and IR pictorial images of a selected portion of the full document to be identified.

35. The system according to claim 29, further comprising a memory for storing the master visible pictorial image and the master IR pictorial image for the known document.

36. A system, comprising:
an optical imager to capture a visible pictorial image on at least one face of a document to be identified;
a magnetic imager to capture a magnetic pictorial image on at least one face of the document to be identified; and
a processor to compare the captured visible pictorial image against a master visible pictorial image for a known document and compare the captured magnetic pictorial image with a master magnetic pictorial image for the genuine document and output an indication, if the comparison indicates a match in images, identifying the document to be of a same type as the known document.

37. The system according to claim 36, wherein the indication identifies the document to be authentic.

38. The system according to claim 36, wherein the indication identifies the document to be of a certain denomination.

39. The system according to claim 36, wherein the document to be identified comprises at least one of a currency bill and a check.

40. The system according to claim 36, wherein the imagers capture the visible and magnetic pictorial images of the full document to be identified.

41. The system according to claim 36, wherein the imagers capture the visible and magnetic pictorial images of a selected portion of the full document to be identified.

42. The system according to claim 36, further comprising a memory for storing the master visible pictorial image and the master magnetic pictorial image for the known document.

43. A system, comprising:
an optical imager to capture a visible pictorial image on at least one face of a document to be identified;
a conductivity imager to capture a conductive pictorial image on at least one face of the document to be identified; and
a processor to compare the captured visible pictorial image against a master visible pictorial image for a known document and compare the captured conductive pictorial image with a master conductive pictorial image for the genuine document and output an indication, if the comparison indicates a match in images, identifying the document to be of a same type as the known document.

44. The system according to claim 43, wherein the indication identifies the document to be authentic.

45. The system according to claim 43, wherein the indication identifies the document to be of a certain denomination.

46. The system according to claim 43, wherein the document to be identified comprises at least one of a currency bill and a check.

47. The system according to claim 43, wherein the imagers capture the visible and conductive pictorial images of the full document to be identified.

48. The system according to claim 43, wherein the imagers capture the visible and conductive pictorial images of a selected portion of the full document to be identified.

49. The system according to claim 43, further comprising a memory for storing the master visible pictorial image and the master conductive pictorial image for the known document.

50. A system, comprising:
a first imager to capture a primary pictorial image detectable at a first observation angle on at least one face of a document to be identified;
a second imager to capture a secondary pictorial image detectable at a second, distinct, observation angle on at least one face of the document to be identified; and
a processor to compare the captured primary pictorial image against a master primary pictorial image for a known document and compare the captured secondary pictorial image with a master secondary pictorial image for the genuine document and output an indication, if the comparison indicates a match in images, identifying the document to be of a same type as the known document.

51. The system according to claim 50, wherein the indication identifies the document to be authentic.

52. The system according to claim 50, wherein the indication identifies the document to be of a certain denomination.

53. The system according to claim 50, wherein the document to be identified comprises at least one of a currency bill and a check.

54. The system according to claim 50, wherein the imagers capture the primary and secondary pictorial images of the full document to be identified.

55. The system according to claim 50, wherein the imagers capture the primary and secondary pictorial images of a selected portion of the full document to be identified.

56. The system according to claim 50, further comprising a memory for storing the primary and secondary pictorial images for the known document.

57. The system according to claim 50, wherein the primary and secondary images are embedded in a hologram.

58. The system according to claim 50, wherein the primary and secondary pictorial images are printed with optical variable ink.

59. The system according to claim 50, wherein the primary and secondary pictorial images are printed with an anti-scan pattern.

60. The system according to claim 50, wherein the primary and secondary pictorial images are embodied by an optical variable device.

61. A system, comprising:
a first imager to capture a primary pictorial image which is observable to the human eye on at least one face of a document to be identified;
a second imager to capture a secondary pictorial image which is not observable to the human eye on at least one face of the document to be identified; and
a processor to compare the captured primary pictorial image against a master primary pictorial image for a known document and compare the captured secondary pictorial image with a master secondary pictorial image for the genuine document and output an indication, if the comparison indicates a match in images, identifying the document to be of a same type as the known document.

62. The system according to claim 61, wherein the indication identifies the document to be authentic.

63. The system according to claim 61, wherein the indication identifies the document to be of a certain denomination.

64. The system according to claim 61, wherein the document to be identified comprises at least one of a currency bill and a check.

65. The system according to claim 61, wherein the imagers capture the primary and secondary pictorial images of the full document to be identified.

66. The system according to claim 61, wherein the imagers capture the primary and secondary pictorial images of a selected portion of the full document to be identified.

67. The system according to claim 61, further comprising a memory for storing the primary and secondary pictorial images for the known document.
